(19) United States
(12) Patent Application Publication
(10) Pub. No.: US 2026/0265608 A1
(43) Pub. Date: Sep. 10, 2026

(54) COMPOSITE

(71) Applicant: UNIVERSITY OF LEEDS, Leeds, Yorkshire (GB)

(72) Inventors: Helen Frances GLEESON, Leeds, Yorkshire (GB); Peter John HINE, Leeds, Yorkshire (GB); Mariam HUSSAIN, Leeds, Yorkshire (GB); Ethan Isaak Luke JULL, Leeds, Yorkshire (GB); Richard MANDLE, Leeds, Yorkshire (GB); Thomas RAISTRICK, Leeds, Yorkshire (GB); Matthew REYNOLDS, Leeds, Yorkshire (GB); Daniel PATERSON, Leeds, Yorkshire (GB); Devesh Arvind MISTRY, Leeds, Yorkshire (GB)

(21) Appl. No.: 19/166,291

(22) PCT Filed: Mar. 20, 2024
(86) PCT No.: PCT/GB2024/050755

§ 371 Date: Sep. 17, 2025

(30) Foreign Application Priority Data
Mar. 21, 2023 (GB) 2304103.1

(51) Int. Cl. C09K 19/52; C09K 19/12

(52) U.S. Cl. CPC C09K 19/52; C09K 19/12; C09K 2019/122; C09K 2019/521

(57) ABSTRACT

A composite containing a plurality of particles interspersed within an elastomer, wherein the elastomer is an auxetic aligned nematic liquid crystal elastomer. Another composite contains first and second outer layers and an interlayer between the first and second outer layers, wherein the interlayer contains an auxetic aligned nematic liquid crystal elastomer.

### CROSS-REFERENCE TO RELATED APPLICATIONS

The present application is a National Stage Application of PCT International Application No.: PCT/GB2024/050755 filed on Mar. 20, 2024, which claims priority to Great Britain Patent Application 2304103.1, filed with the British Patent Office on Mar. 21, 2023, the disclosures of which are incorporated herein by reference in their entirety.

### TECHNICAL FIELD

The present invention relates to a composite comprising an aligned nematic liquid crystal elastomer.

### BACKGROUND

Composites may be laminar, comprising a plurality of layers. Other types of composites may be particulate composites, wherein particles of a first material are provided in a second material. Composites are used in a large range of industries, such as aerospace and aeronautical structures, automotive structuring and micro-electro-mechanical systems.

Debonding can be a significant issue in composite systems. Layers of a laminar composite may become separated and particles may become separated from a surrounding material in particulate composites. Such separation can arise from a plurality of factors, including free edge effects, structural discontinuities and localised disturbances resulting from impact, moisture and temperature variations. The thermo-mechanical reliability of micro-electronic packaging is a major concern of the electronics industry. Delamination is also a significant issue faced by the glass industry.

Some composite systems may excrete a self-healing material when debonding occurs, which may act to prevent the debonding. Fibre composite systems may utilise Z-pin bridging, wherein through-thickness reinforcement is provided. However, such methods of tackling de-bonding may only be effective for some composite systems.

### SUMMARY

According to the present invention there is provided an apparatus and method as set forth in the appended claims. Other features of the invention will be apparent from the dependent claims, and the description which follows.

According to a first aspect, there is provided a composite comprising an auxetic aligned liquid crystal elastomer.

The composite may be a particulate composite and may comprise a plurality of particles interspersed within the elastomer. The composite may be a laminar composite and the elastomer may form an interlayer between first and second outer layers.

An aligned nematic liquid crystal elastomer having auxetic properties has recently been developed, as described in WO2019077361A1. An auxetic material has a negative Poisson's ratio, where the Poisson's ratio is described as the negative ratio of the proportional decrease in a lateral measurement to the proportional increase in length in a sample of material that is stretched. On stretching, auxetic materials become thicker in one or both of the directions perpendicular to the applied deformation.

It has surprisingly been found that a composite comprising an auxetic aligned nematic liquid crystal elastomer provides resistance to debonding. In composites wherein particles are interspersed within the elastomer, it has been found that there is an improved resistance to debonding between the elastomer and the particles. The debonding resistance properties of the composite may be useful in applications such as body armour or semi-conductor packaging. In composites wherein the liquid crystal elastomer is an interlayer between first and second outer layers, delamination between the layers can be reduced. Such a composite may be used in applications such as automotive glazing and photovoltaic device encapsulants, wherein the intermediate layer of auxetic aligned nematic liquid crystal elastomer may replace incumbent interlayer materials such as polyvinyl butyral layers.

The particulate composite may be a film. The film may have a thickness of ≤100 μm. In other examples, the film may have a thickness of greater than 100 μm.

The particles may be of any shape. Preferably, the particles may be spherical. In other examples, the particles may be elongate, such as rod-shaped.

The size of the particles may be smaller than the thickness of the film. The spherical particles may have a diameter≤100 μm. Preferably, the spherical particles may have a diameter of 10 μm. In other examples, the particles may have a diameter of greater than 100 μm.

The liquid crystal elastomer may be a monodomain liquid crystal elastomer. By “monodomain” herein is meant that the director orientation of the elastomer is macroscopically aligned in the sample. Monodomain alignment over the sample can be determined, for example, by polarising microscopy where it is characterised by uniform birefringence when the macroscopic sample is viewed between crossed polarisers.

The liquid crystal elastomer may be aligned in a direction of a longitudinal axis of the film.

In the laminar composite, the auxetic liquid crystal elastomer may be aligned in a predetermined direction. The predetermined direction may be substantially parallel to the outer layers or perpendicular to the outer layers. In other examples, the predetermined direction may be at an oblique angle relative to the outer layers. The laminar composite may comprise an alignment layer between at least one of the first and second outer layers, wherein the alignment layer is configured to promote alignment of the liquid crystal elastomer in the predetermined direction. In the laminar composite, at least one of the outer layers may be glass.

In the particulate composite, the bulk of the liquid crystal elastomer may have monodomain alignment, and the liquid crystal elastomer may have a different alignment in proximity of the particles. The nematic liquid crystal elastomer molecules may be aligned parallel or perpendicular to the surface of the particles. The alignment of the liquid crystal molecules around the particles may depend on the material of the particles.

The particulate composite may comprise an alignment surface provided on the surface of the particles, wherein the alignment surface is configured to promote alignment of the liquid crystal elastomer in a direction parallel or perpendicular to the surface of the particles. The particles may be pre-treated to select a perpendicular or parallel alignment. For example, a solution may be applied to the particles to promote alignment.

Although a few preferred embodiments of the present invention have been shown and described, it will be appreciated by those skilled in the art that various changes and modifications might be made without departing from the scope of the invention, as defined in the appended claims.

### BRIEF DESCRIPTION OF THE DRAWINGS

For a better understanding of the invention, and to show how embodiments of the same may be carried into effect, reference will now be made, by way of example only, to the accompanying diagrammatic drawings in which:

FIG. 1 shows a first example of a composite;

FIG. 2 shows a second example of a composite;

FIGS. 3A and 3B show graphs indicating the auxetic threshold of an aligned nematic liquid crystal elastomer;

FIGS. 4A-E show images of an aligned nematic liquid crystal elastomer with embedded particles; and

FIGS. 5A-F show images of an isotropic elastomer with embedded particles.

### DETAILED DESCRIPTION

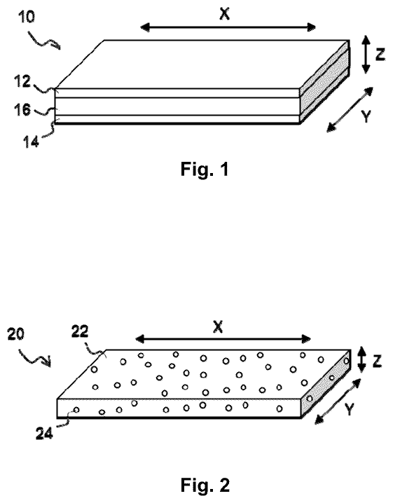

As shown in FIG. 1, an example composite 10 comprises a first outer layer 12, a second outer layer 14, and an intermediate layer 16 between the first and second outer layers 10, 12. The intermediate layer 16 is formed of an auxetic aligned nematic liquid crystal elastomer, such as the liquid crystal elastomer described below in example 1.

The nematic liquid crystal elastomer is aligned in a direction Y parallel to the outer layers. When strain is applied in the X direction, the liquid crystal elastomer undergoes a mechanical Fréedericksz transition (MFT), in which the direction of alignment effectively rotates to the Z direction.

A mechanical Fréedericksz transition is defined as a deformation mode of an aligned elastomer wherein the director within the plane of the elastomer film appears to rotate sharply at a critical strain to reorient towards the direction parallel to the stress axis at a critical extension. Materials displaying this property were first described by Mitchell et al (Mitchell, G. R., Davis, F. J. and Guo, W., Phys. Rev. Lett., 1993, 71 (18), 2947) and Roberts et al (Roberts, P. M. S., Mitchell, G. R and Davis, F. J., J. Phys, II France, 1997, 7, 1337 and Roberts, P. M. S., Mitchell, G. R, Davis, F. J. and Pople, J. A., Mol. Cryst. Liq. Cryst., 1997, 299, 181). An MFT is often described in analogy to the well-known electric (or magnetic) field Fréedericksz transitions (EFT) that occur in low molar mass nematic display devices. In the EFT, the director reorients sharply beyond a well-defined critical field (or voltage), becoming increasingly aligned with respect to the electric field as the amplitude of the field is increased. The EFT threshold is discontinuous in theory, but is known to be softened if an ideal LC monodomain with alignment exactly parallel or perpendicular to the substrates is not achieved in practice. The threshold is nonetheless sharp and well-defined. The apparent sharp rotation of the director seen in an MFT is different from the director rotation response for an aligned elastomer which deforms via semi-soft elasticity (SSE), the alternative deformation mode. In the case of semi-soft elasticity, the director rotates comparatively gradually, and in the plane of the deformation, over a plateau-like region of the tensile load curve.

As shown in FIG. 2, another example composite 20 comprises a film formed of an auxetic aligned nematic liquid crystal elastomer 22 and a plurality of particles 24 interspersed therein. In the composite 20, the bulk of the liquid crystal elastomer is aligned in the Y direction, whilst in the proximity of the particles 24, the liquid crystal elastomer is arranged around the particles. When strain is applied in the X direction, the liquid crystal elastomer undergoes an MFT, in which the direction of alignment rotates to the Z direction.

### Examples

Auxetic aligned nematic liquid crystal elastomers for use according to the invention were synthesised as follows using the following materials:
2-ethylhexyl acrylate (EHA),
6-(4-cyano-biphenyl-4′-yloxy) hexyl acrylate (A6OCB),
1,4-bis-[4-(6-acryloyloxyhexyloxy)benzoyloxy]-2-methylbenzene (RM82),
4-cyano-4′-hexyloxybiphenyl (6OCB) and
methyl benzoylformate (MBF).

The elastomers were prepared using the following starting monomer mixture:

| | Material % by mol |
|---|---|
| Component | Example 1 |
| A6OCB | 28.4 |
| 6OCB | 50.90 |
| RM82 | 7.88 |
| EHA | 12.1 |
| MBF | 0.7 |

Silica microspheres (1% wt) with 10 μm diameter and without a surface treatment were immersed into the liquid crystal monomer mixture. In other example, particles of other materials and diameters may be immersed into the liquid crystal monomer mixture.

Films of liquid crystal elastomer were produced by polymerising the monomer mixture inside thin film moulds of approximately 100 μm thickness, a width of approximately 15 mm and a length of approximately 60 mm. A first film, according to the invention, was cured in the nematic phase at room temperature, with planar alignment, where the surface of the mould was coated with a thin layer of PVA alignment layer and the rubbing direction was anti-parallel. In other examples, other alignment layers may be used, for example polyimide. A second film, as a comparative example, was cured in the isotropic phase at 50° C., with no alignment layer. A third film, as a comparative example, was cured in the nematic phase at room temperature, with planar alignment, without the microsphere particles present. Each of the first film, second and third films were polymerised for two hours. After polymerisation, the films were removed from the moulds and kept in a methanol/DCM solvent mixture overnight in order to wash out the 6OCB.

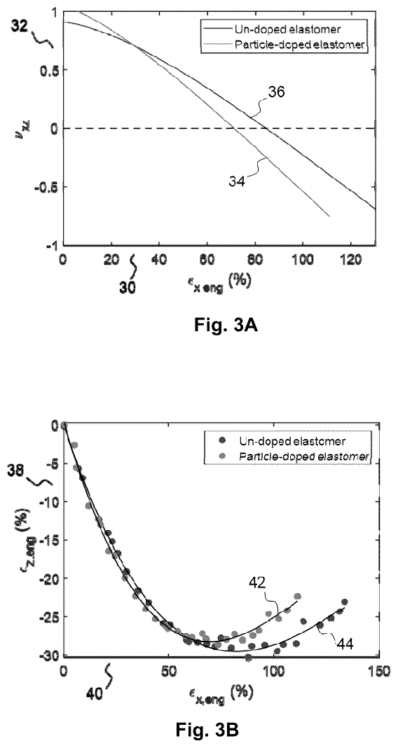

FIGS. 3A and 3B show that auxetic behaviour is present in the first film. Strain in the x-direction was applied and strains in the x- and y-directions were measured by particle tracking as the elastomer was deformed in the x direction. The particles selected were close to the centre of the elastomer. The strain in the z-direction (the auxetic response) is calculated based on the measured strains in the x- and y-direction, using Equation 1, by assuming that the volume of the liquid crystal elastomer remains constant:

$${ε}_{z} = \frac{1}{( 1 + {ε}_{x} ) ( 1 + {ε}_{y} )} - 1 \qquad ( Equation l )$$

The Poisson's ratio, v_{xz}, is determined using Equation 2, wherein the true strain is determined based on the engineering strain using Equation 3.

$${v}_{x z} = - d {ε}_{z , true} / {d ε}_{x , true} \qquad ( Equation 2 )$$

$${ε}_{true} = ln ( {ε}_{eng} + 1 ) \qquad ( Equation 3 )$$

FIG. 3A shows the instantaneous Poisson's ratio as a function of strain, and FIG. 3B shows the strain in the z-direction as a function of strain in the x-direction. FIG. 3A shows that as x-strain (axis 30) increases, the Poisson's ratio (axis 32) decreases and becomes negative, thereby indicating auxetic behaviour. FIG. 3A shows that that the Poisson's ratio becomes negative for the first film (labelled 34 in FIG. 3A) at a lower strain than for the third film, without particles present (labelled 36 in FIG. 3A). FIG. 3B shows the auxetic threshold at the point at which z-strain (axis 38) increases with increased x-strain (axis 40). FIG. 3B shows that the first film with the particles present (labelled 42 in FIG. 3B) has an auxetic threshold at a reduced x-strain compared to the third film without particles present (labelled 44 in FIG. 3B).

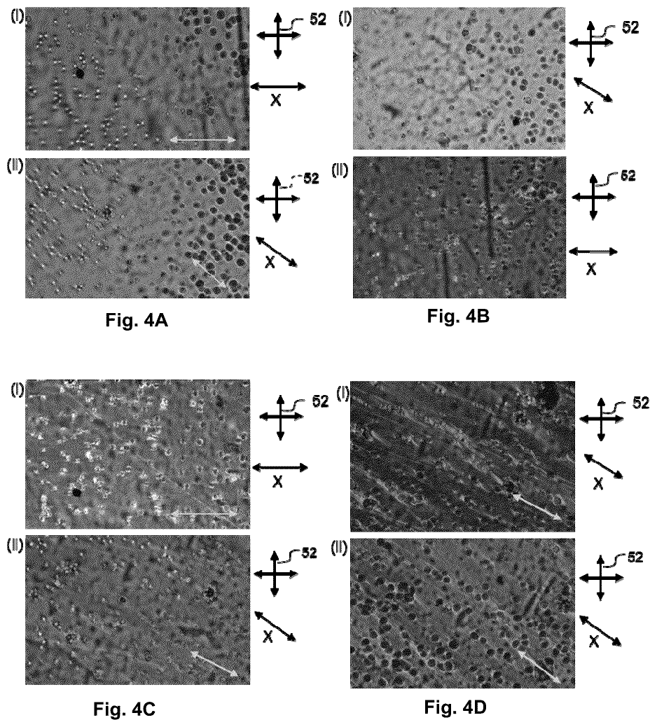

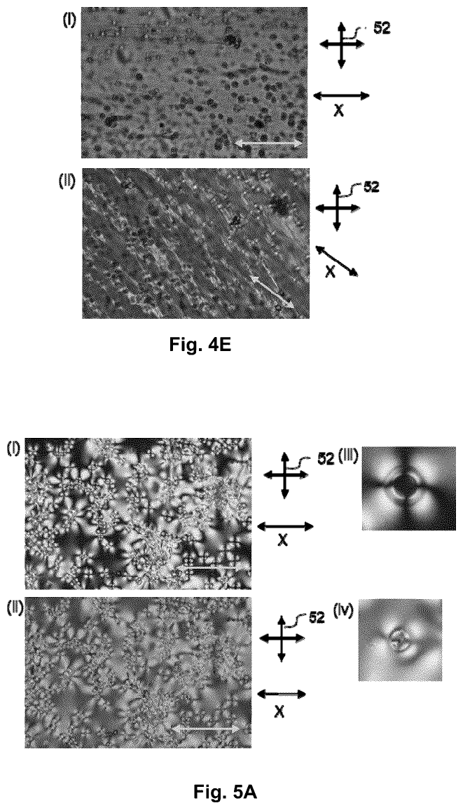

The debonding resistance of the first film is demonstrated in FIGS. 4A-4E. The images in FIGS. 4A-4E were captured while the first film was strained when positioned between crossed polarisers with a 50× objective. The film was strained by a step size of 0.2 mm and allowed to relax for 120 seconds prior to the next strain step. The strain was provided along the axis indicated by arrow X in FIGS. 4A-4E. In each of FIGS. 4A-4E, the image labelled (i) shows the appearance of the first film through crossed polarisers and the image labelled (ii) shows the appearance of the first film through crossed polarisers with a wave-plate. The position of the crossed-polarisers is indicated by label 52.

FIG. 4A shows the appearance of the first film prior to straining; FIG. 4B shows the appearance of the first film with a strain of 0.25; FIG. 4C shows the appearance of the first film with a strain of 0.5; FIG. 4D shows the appearance of the first film with a strain of 0.75; FIG. 4E shows the appearance of the first film with a strain of 1. FIGS. 4A to 4E show no evidence of separation of the liquid crystal elastomer from the spherical particles. A change in birefringence is shown by the striations in the images at high strain (FIGS. 4D and 4E), which can be attributed to the consequences of the MFT and strain interactions between the particles.

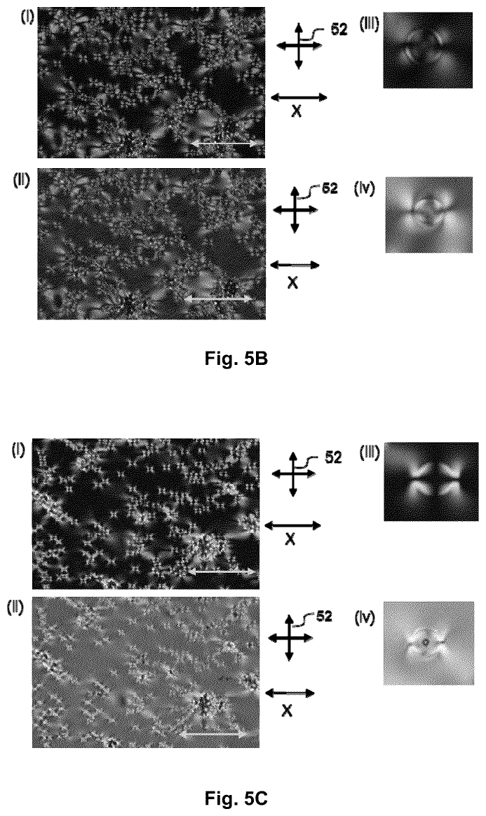

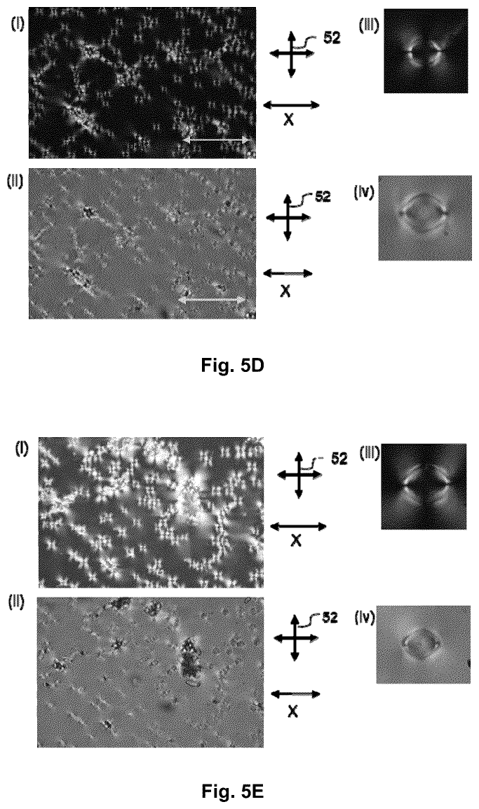

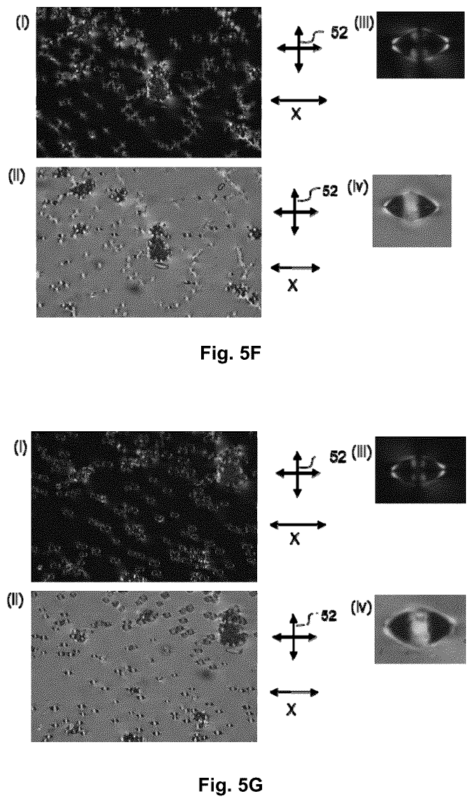

FIGS. 5A-5G show a comparative example, wherein the second film was strained in the X direction when positioned between crossed polarisers. The images in FIGS. 5A-5G were captured while the second film was strained when positioned between crossed polarisers with a 50× objective. The second film was strained by a step size of 0.2 mm and allowed to relax for 120 seconds prior to the next strain step. In each of FIGS. 5A-4G, the image labelled (i) shows the appearance of the second film through crossed polarisers; the image labelled (ii) shows the appearance of the second film through crossed polarisers with a wave-plate; the image labelled (iii) shows the appearance of a single particle in the second film through crossed polarisers; and the image labelled (iv) shows the appearance of a single particle in the second film through crossed polarisers with a wave-plate. The position of the crossed-polarisers is indicated by label 52.

FIG. 5A shows the appearance of the second film prior to straining; FIG. 5B shows the appearance of the second film with a strain of 0.13; FIG. 5C shows the appearance of the second film with a strain of 0.32; FIG. 5D shows the appearance of the second film with a strain of 0.5; FIG. 5E shows the appearance of the second film with a strain of 0.65; FIG. 5F shows the appearance of the second film with a strain of 0.84; FIG. 5G shows the appearance of the second film with a strain of 0.97. FIGS. 5F and 5G show that separation of the liquid crystal elastomer from the spherical particles is present at higher strains. This separation is visible as black triangles on left and right sides of the particles. In FIG. 5F, some of the particles show this defect and in FIG. 5G, almost all of the particles show this defect. Local strain between the particles causes birefringence, which is very small. The black background in the images labelled (i) in FIGS. 5A-5G is due to the elastomer being isotropic in those regions.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A composite comprising a plurality of particles interspersed within an elastomer, wherein the elastomer is an auxetic aligned nematic liquid crystal elastomer.

2. The composite according to claim 1, wherein the composite is a film.

3. The composite according to claim 1, wherein the plurality of particles are spherical.

4. The composite according to claim 3, wherein the plurality of particles have a diameter of ≤100 μm.

5. The composite according to claim 1, wherein the plurality of particles are elongate.

6. The composite according to claim 1, wherein the liquid crystal elastomer is a monodomain liquid crystal elastomer.

7. The composite according to claim 1, further comprising an alignment surface provided on the surface of the plurality of particles, wherein the alignment surface is configured to promote alignment of the liquid crystal elastomer in a direction parallel or perpendicular to the surface of the plurality of particles.

8. A composite comprising first and second outer layers and an interlayer between the first and second outer layers, wherein the interlayer comprises an auxetic aligned nematic liquid crystal elastomer.

9. The composite according to claim 8, wherein the liquid crystal elastomer is a monodomain liquid crystal elastomer, with a predetermined alignment direction substantially parallel to the first and second outer layers.

10. The composite according to claim 9, further comprising an alignment layer between at least one of the first and second outer layers, wherein the alignment layer is configured to promote alignment of the liquid crystal elastomer in the predetermined alignment direction.

11. The composite according to claim 8, wherein at least one of the first and second outer layers is glass.
